(19) United States
(12) Patent Application Publication
(10) Pub. No.: US 2015/0000146 A1
(43) Pub. Date: Jan. 1, 2015

(54) Identification structure for a patchwork ruler

(71) Applicant: Pi-Chao Chang, Taichung City (TW)

(72) Inventor: Pi-Chao Chang, Taichung City (TW)

(21) Appl. No.: 13/929,815

(22) Filed: Jun. 28, 2013

(51) Int. Cl. B43L 12/00

(52) U.S. Cl. CPC B43L 12/00
USPC 33/493

(57) ABSTRACT

An anti-slip identification structure for a patchwork ruler contains a body, and the body including a marking portion, a contrast marking portion, a scale portion, a plurality of angle lines, and plural grid lines which are arranged on the body. The body includes an anti-slip painting layer painted on a bottom end thereof and it being translucent. Thereby, a darker marking portion is suit for cloth materials with a deep color or a light color so as to identify the marking portion, the contrast marking portion, the scale portion, the plurality of angle lines, and the plural grid lines clearly and to fix a patchwork ruler securely.

### FIELD OF THE INVENTION

The present invention relates to an identification structure for a patchwork ruler which is identified clearly and is fixed securely.

### BACKGROUND OF THE INVENTION

As shown in FIG. 6, a conventional patchwork ruler 30 is made of Acrylic material and is transparent. The patchwork ruler 30 includes a marking portion 31 fixed thereon so as to identify a size of cloth materials.

But the patchwork ruler 30 has a smooth surface, so a user cannot position the patchwork ruler 30 fixedly. Referring further to FIGS. 7 and 8, the marking portion 31 of the patchwork ruler 30 has a black marking area 40 or a light-color marking area 41, wherein the black marking area 40 is applicable for cloth materials with a dark color, and the light-color marking area 41 is suitable for other cloth materials with a light color, such that the patchwork ruler 30 is distinguished by a contrast color difference.

In addition, the marking portion 31 of the patchwork ruler 30 can have a combined marking area 42 with a dark color and a light color arrangement so as to match with different using requirements.

However, when the patchwork ruler 30 is transparent, it cannot be used in the cloth materials with a dark color or a light color; when the patchwork ruler 30 has the combined marking area 42, it cannot be fixed securely because of its smooth surface.

### SUMMARY OF THE INVENTION

The primary object of the present invention is to provide an identification structure for a patchwork ruler in which a darker marking portion is suit for cloth materials with a deep color or a light color so as to identify the marking portion, the contrast marking portion, the scale portion, the plurality of angle lines, and the plural grid lines clearly and to fix a patchwork ruler securely.

To obtain the above objectives, an identification structure for a patchwork ruler provided by the present invention contains:
a body, and the body including a marking portion, a contrast marking portion, a scale portion, a plurality of angle lines, and plural grid lines which are arranged on the body.

The body includes an anti-slip painting layer painted on a bottom end thereof and being translucent.

Preferably, the anti-slip painting layer is painted on bottom ends of the marking portion, the contrast marking portion, the scale portion, the plurality of angle lines, and the plural grid lines of the body.

### BRIEF DESCRIPTION OF THE DRAWINGS

FIG. 1 is a perspective view showing the assembly of an identification structure for a patchwork ruler according to a preferred embodiment of the present invention.

FIG. 2 is a top plan view showing the assembly of the identification structure for the patchwork ruler according to the preferred embodiment of the present invention.

FIG. 3 is another perspective view showing the assembly of the identification structure for the patchwork ruler according to the preferred embodiment of the present invention.

FIG. 4 is a cross sectional view showing the assembly of a part of the identification structure for the patchwork ruler according to the preferred embodiment of the present invention.

FIG. 5 is a partially plan view showing the operation of the identification structure for the patchwork ruler according to the preferred embodiment of the present invention.

FIG. 6 is a perspective view showing the assembly of a conventional patchwork ruler.

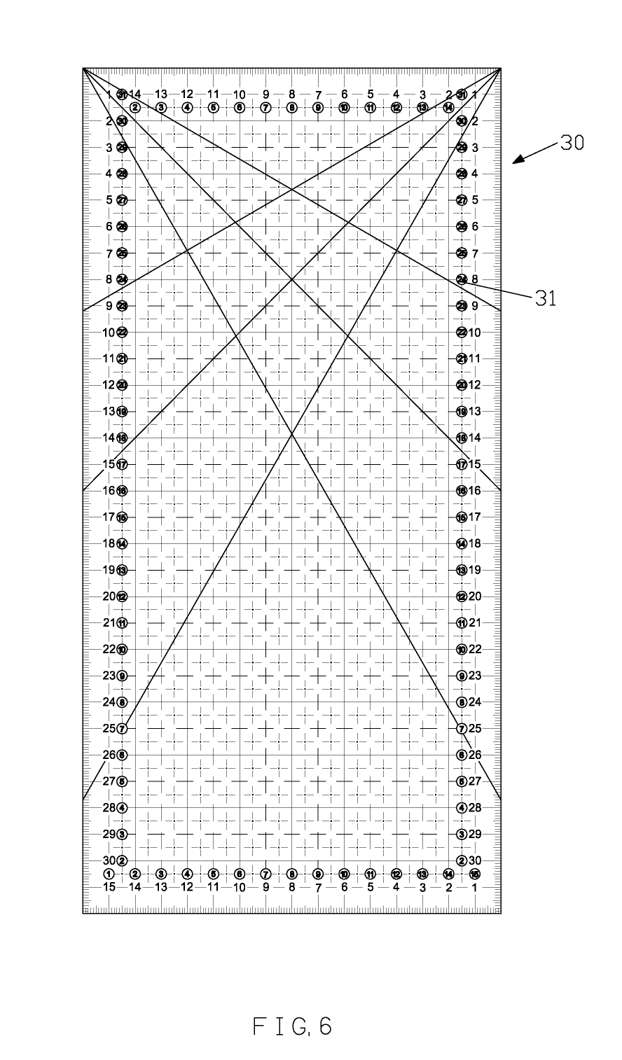

FIG. 7 is a partially plan view showing the operation of the conventional patchwork ruler.

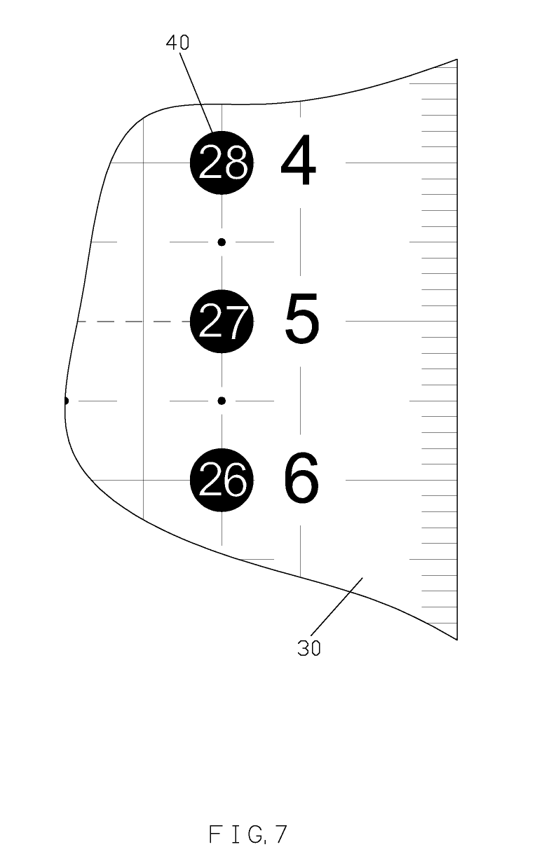

FIG. 8 is another partially plan view showing the operation of the conventional patchwork ruler.

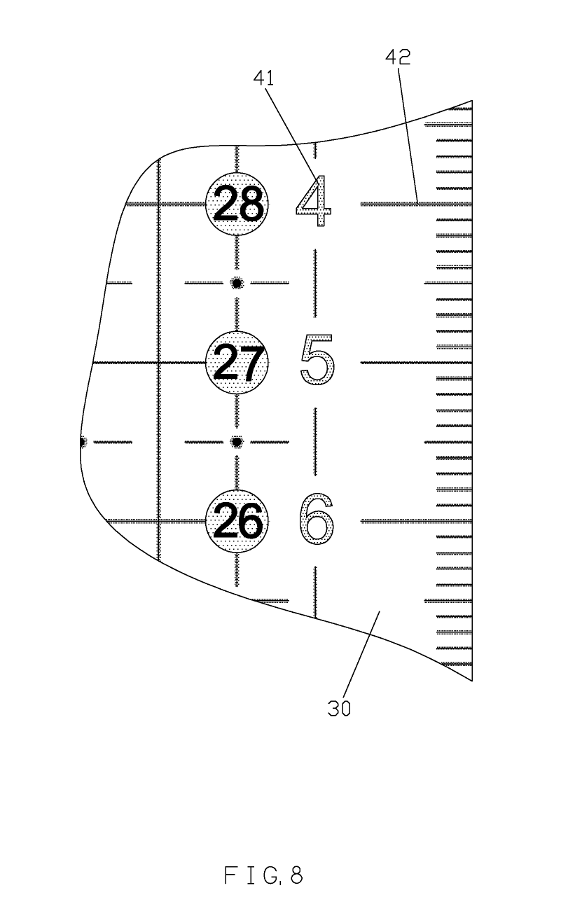

### DETAILED DESCRIPTION OF THE PREFERRED EMBODIMENTS

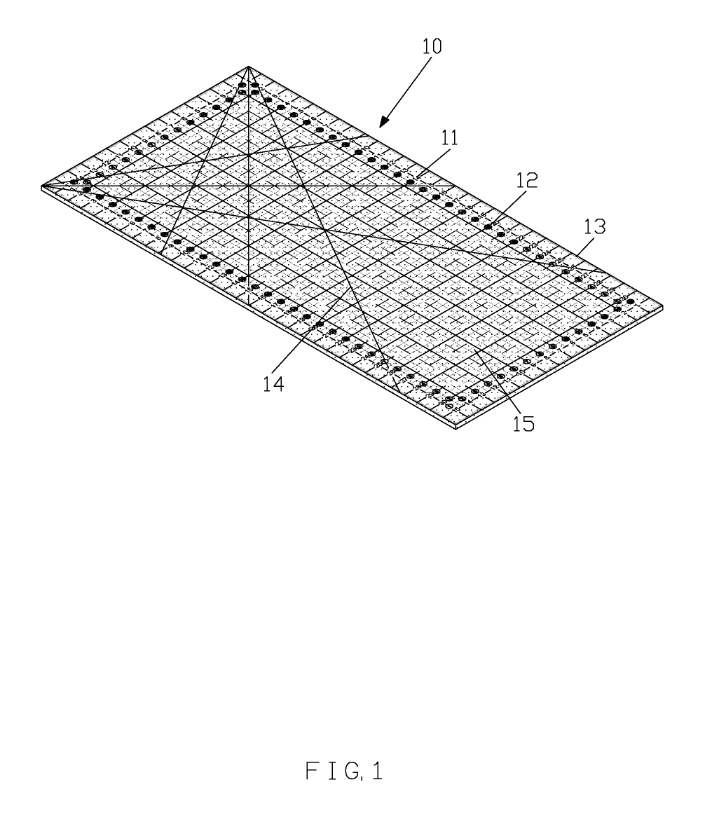

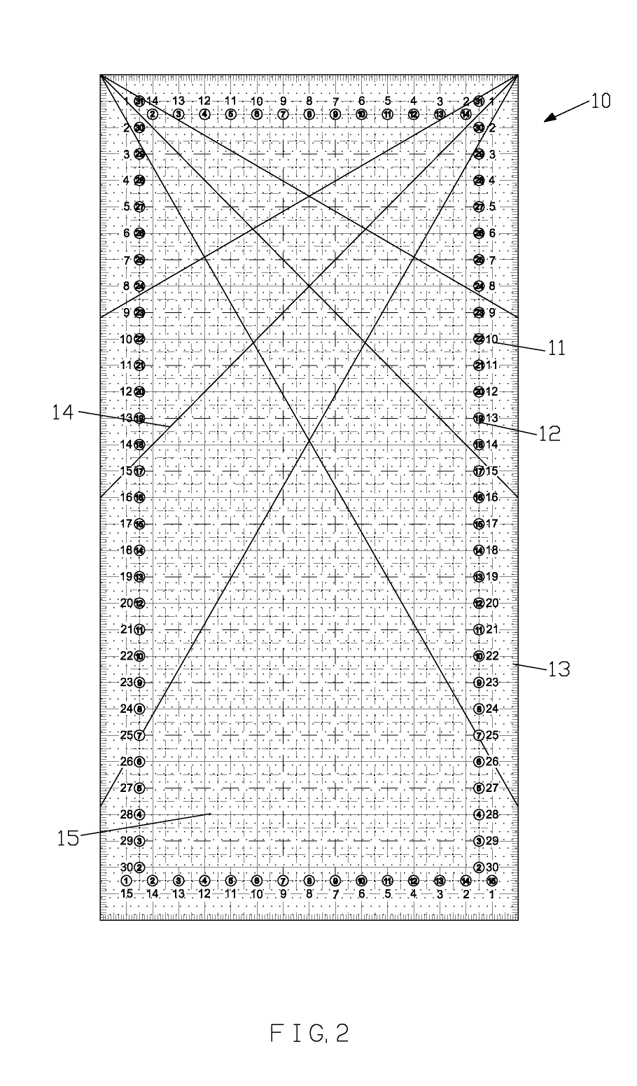

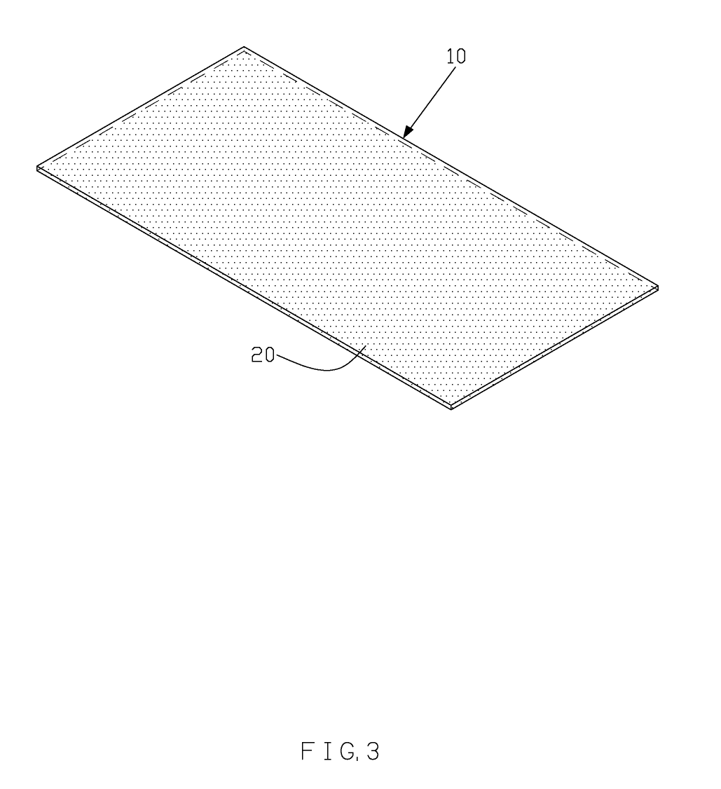

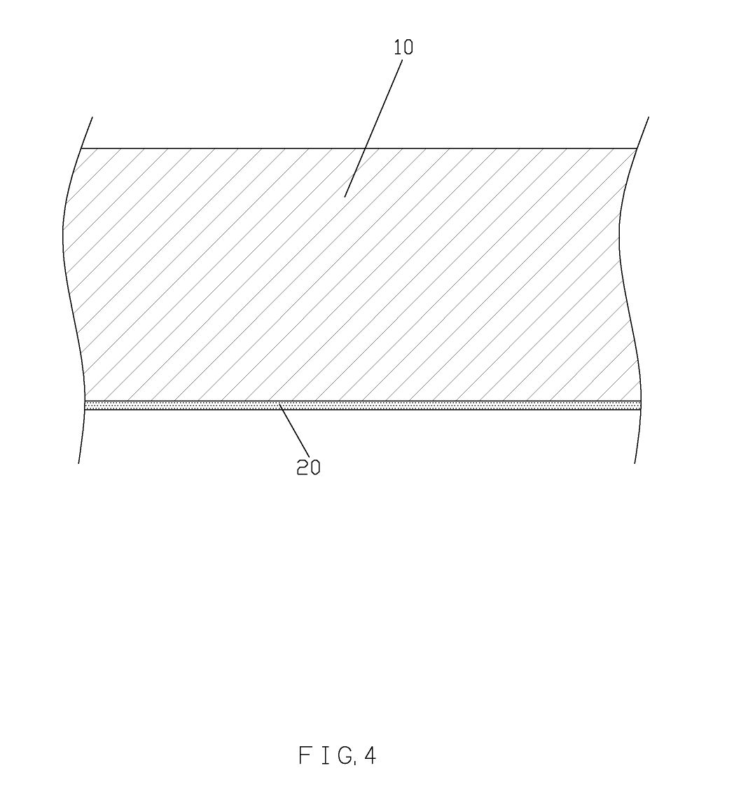

Referring to FIGS. 1-4, an identification structure for a patchwork ruler according to a preferred embodiment of the present invention comprises a body 10 including a marking portion 11, a contrast marking portion 12, a scale portion 13, a plurality of angle lines 14, and plural grid lines 13. The body 10 includes an anti-slip painting layer 20 painted on a bottom end thereof so as to obtain an-slip function, and the anti-slip painting layer 20 is translucent. It is to be noted that the anti-slip painting layer 20 is also used to prevent the body 10 from being scraped.

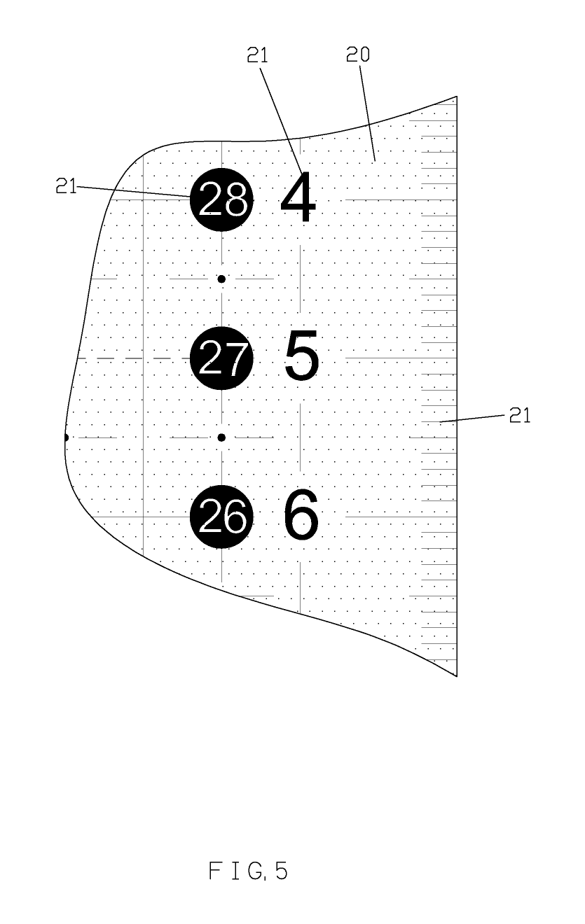

Referring further to FIGS. 1 and 5, since the anti-slip painting layer 20 is translucent, a darker marking portion 21 is suit for cloth materials with a deep color or a light color so as to identify the marking portion 11, the contrast marking portion 12, the scale portion 13, the plurality of angle lines 14, and the plural grid lines 13 clearly and to fix a patchwork ruler securely.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

20

What is claimed is:

1. An anti-slip identification structure for a patchwork ruler comprising a body, and the body including a marking portion, a contrast marking portion, a scale portion, a plurality of angle lines, and plural grid lines which are arranged on the body;
wherein the body includes an anti-slip painting layer painted on a bottom end thereof and being translucent.

2. The anti-slip identification structure for the patchwork ruler as claimed in claim 1, wherein the anti-slip painting layer is painted on bottom ends of the marking portion, the contrast marking portion, the scale portion, the plurality of angle lines, and the plural grid lines of the body.
